(19) United States
(12) Patent Application Publication
(10) Pub. No.: US 2023/0135725 A1
(43) Pub. Date: May 4, 2023

(54) MODIFIED LIGNIN REINFORCED RUBBER AND PREPARATION METHOD THEREFOR

(71) Applicant: NANJING TECH UNIVERSITY, Nanjing (CN)

(72) Inventors: Chenjie ZHU, Nanjing (CN); Xinjian XU, Nanjing (CN); Hanjie YING, Nanjing (CN); Ming LI, Nanjing (CN); Wei ZHUANG, Nanjing (CN); Pingkai OUYANG, Nanjing (CN); Tao SHEN, Nanjing (CN); Junqiang SHAN, Nanjing (CN)

(21) Appl. No.: 17/904,008

(22) PCT Filed: Mar. 24, 2021
(86) PCT No.: PCT/CN2021/082680

§ 371 Date: Aug. 10, 2022

(30) Foreign Application Priority Data
Jun. 1, 2020 (CN) 202010484885.2

(51) Int. Cl. C08L 97/00; C08K 3/22; C08K 3/04; C08L 23/22; C08L 11/00; C08K 5/36; C08K 5/01

(52) U.S. Cl. CPC C08L 97/005; C08K 3/22; C08K 3/04; C08L 23/22; C08L 11/00; C08K 5/36; C08K 5/01; C08L 2205/05

(57) ABSTRACT

A modified lignin reinforced rubber is obtained by subjecting a lignin to composite modification by a compound containing a carbon-carbon double bond, a compound containing a sulfur element and a compound capable of blocking a hydroxyl; the lignin is modified with the compound containing the carbon-carbon double bond, and the contained double bond and an olefin in the rubber generate a bonding effect, which improves a binding force between the lignin and the rubber; furthermore, by modifying the lignin with the compound containing the sulfur element, the lignin contains a certain amount of the element sulfur, which improves an interaction between the lignin and the rubber, improves properties of the rubber, and reduces the use of a vulcanizing agent, and further increases a replacement amount of the lignin to carbon black.

### TECHNICAL FIELD

The present invention belongs to the field of rubber, and more particularly, relates to a modified lignin reinforced rubber and a preparation method therefor.

### BACKGROUND

Natural rubber (NR) is a natural polymer compound with cis-1,4-polyisoprene as the main component. 91%-94% of the components are rubber hydrocarbon (cis-1,4-polyisoprene) and the rest are non-rubbery substances such as proteins, fatty acids, ash, sugars, and the like. The natural rubber is the most widely used general-purpose rubber. At present, in order to further improve properties of the rubber while reducing the industrial use cost of the rubber, it is usually necessary to fill the rubber with other materials^{[1]}, such as carbon black, silica, and the like. In recent years, the study on the application of inorganic materials such as clay, calcium carbonate, talc, and montmorillonite to the rubber has gradually increased. However, with the increasing tension of energy, there is an urgent need to find new energy sources for sustainable development.

As the world's second largest biomass resource after cellulose, lignin has a highly cross-linked molecular structure and other excellent properties such as excellent aging resistance and thermal stability, and the application of the lignin in the field of rubber is gradually growing, which can effectively solve the problem of environmental pollution caused by the long-term use of the lignin as waste in the biorefinery and paper industries in the prior art, and also realize the renewable use of resources. Zhang Cuimei^{[2]} et al. studied the direct application of alkali lignin in rubber. The results showed that when the content of the alkali lignin was 10% to 50%, there was almost no filler network in the rubber compound, and the interaction between the rubber and the filler was weak, resulting in agglomeration of alkali lignin particles. Therefore, when the lignin is directly applied to the rubber, agglomeration may be caused, which is not conducive to the improvement of overall properties. A previous study of our laboratory, “Lignin-unsaturated Carboxylate Compound Reinforcing Agent and Application thereof in Rubber”, showed that the chelation between polar groups of the lignin and metal ions of the unsaturated carboxylate could effectively weaken the intermolecular force of the lignin itself, thus weakening the agglomeration of the lignin, which was more conducive to the dispersion of the lignin in a rubber matrix, and the ionic crosslink was generated during the vulcanization of the rubber, thus improving the mechanical properties of the rubber. However, the lignin-unsaturated carboxylate was obtained by grinding the lignin and the unsaturated carboxylate. Grinding not only consumed a lot of energy, but also caused some dust pollution. At the same time, grinding led to some disadvantages such as uneven particle size, thus affecting the properties of the rubber. Meanwhile, this modification method has no significant change on an interaction between the lignin and the rubber, so it is necessary to develop a new, convenient, green and environmental-friendly modification method with low energy consumption to promote the application of the lignin in the rubber field.
[1] Biopolymers, (Volume 2): Polyisoprenoids [M], edited by T. Koyama, and A. Steinbuchel, Beijing Chemical Industry Press, 2004.
[2] Study on Properties of Natural Rubber Filled with Alkali Lignin [J], 2017/Vol. 3, Biomass Chemical Engineering, edited by Zhang CuiMmei, Cui Xuejing, Sun Yanni, Jiang Ruiyu, Zhao Jiruo, and Feng Ying.

### SUMMARY

Object of the present invention: the technical problem to be solved by the present invention is to provide a modified lignin reinforced rubber aiming at the deficiencies of the prior art.

Idea of the present invention: in the prior art, in the rubber field, due to uneven dispersion of lignin and weak bonding strength between the lignin and the rubber, the development of the lignin in the rubber field is limited to some extent. Therefore, aiming at the above problems, the present invention develops a lignin modified by a compound containing a carbon-carbon double bond, a compound containing a sulfur element and a compound capable of blocking a hydroxyl, and then applies the modified lignin to the rubber field. Firstly, the lignin is modified by the compound containing the carbon-carbon double bond and the compound containing the sulfur element, such that the lignin can have a long chain containing the carbon-carbon double bond and a certain sulfur element at the same time, so that when the lignin reacts with the rubber, the contained double bond can generate a bonding effect with olefins in the rubber, to improve a binding force between the lignin and the rubber; moreover, the long chain of the modified lignin can also be entangled with the rubber, thus further improving an interaction between the two. Further, the modified lignin contains a certain sulfur element, which can further improve the binding force with the rubber in a vulcanization process, further improve properties of the prepared rubber, and reduce the use of a vulcanizing agent. Finally, after being modified by the compound capable of blocking the hydroxyl, a polarity of the lignin can be significantly reduced, such that the polarity of the lignin is closer to that of the rubber, thus further improving the interaction between the rubber and the lignin, and integrally improving the properties of the rubber.

Another technical problem to be solved by the present invention is to provide a preparation method for the modified lignin reinforced rubber above.

In order to solve the foregoing technical problem, the present invention discloses a preparation method for a modified lignin reinforced rubber, wherein the modified lignin is obtained by subjecting a lignin to composite modification by a compound containing a carbon-carbon double bond, a compound containing a sulfur element and a compound capable of blocking a hydroxyl.

If the compound can contain both the carbon-carbon double bond and the sulfur element, it is possible to use the only one compound to substitute the compound only containing the carbon-carbon double bond and the compound only containing the sulfur element respectively.

The lignin is one or a combination of a plurality of alkali lignin, soda lignin, organic solvent lignin and enzymatic hydrolysis lignin.

The compound containing the carbon-carbon double bond is a compound containing any one of vinyl, acrylic, butadiene, oleic, linoleic, linolenic, arachidonic and dienyl phthalate groups.

Preferably, the compound containing the carbon-carbon double bond is a compound containing any one or a combination of two of vinyl and acrylic groups.

The compound containing the acrylic group comprises, but is not limited to zinc acrylate, magnesium acrylate and calcium acrylate.

Further preferably, the compound containing the carbon-carbon double bond is a long-chain compound containing no less than five carbon atoms; and more preferably, is a long-chain compound containing no less than ten carbon atoms.

More preferably, the long-chain modifier is vinylsilane; wherein, the vinylsilane is any one of vinyltrimethoxysilane, vinyltriethoxysilane, vinyltris(2-methoxyethoxy)silane, tri(isopropoxy)vinylsilane, vinyl(2-methoxyethoxy)silane and vinyltriacetoxysilane.

The compound containing the sulfur element is any one or a combination of a plurality of sulfhydryl silane coupling agent shown in formula I, bis[3-(triethoxysilyl)propyl]tetrasulfide, mercaptan, potassium persulfate, mercaptobenzothiazole, brimstone and tetramethyl thiuram monosulfide; and preferably, the compound containing the sulfur element is one or a combination of a plurality of bis[3-(triethoxysilyl)propyl]tetrasulfide, mercaptobenzothiazole, brimstone and tetramethyl thiuram monosulfide.

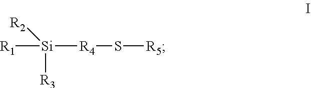

wherein, R₁, R₂ and R₃ are independently selected from —O—R₆; wherein, R₆ is selected from alkyl, alkenyl, aryl or aralkyl; R₄ is selected from —(CH2)n-; wherein, n is any integer selected from 1 to 10; R₅ is selected from H, CN or (C═O)—R⁶; wherein, R⁶ is selected from branched or unbranched, saturated or unsaturated aliphatic, aromatic or mixed aliphatic/aromatic monovalent C1-C30 hydrocarbyl groups.

Preferably, R₁, R₂ and R₃ are independently selected from —OCH₃ or —OCH₂CH₃; n is selected from 2 to 10; and R₅ is H.

Further preferably, the sulfhydryl silane coupling agent shown in formula I is 3-mercaptopropyltriethoxysilane or (3-mercaptopropyl)trimethoxysilane.

The compound capable of blocking the hydroxyl is one or a combination of a plurality of silane coupling agent, titanate coupling agent and aluminate coupling agent.

The silane coupling agent comprises, but is not limited to vinylsilane, which is vinyltrimethoxysilane, vinyltriethoxysilane, vinyltris(2-methoxyethoxy)silane, tri(isopropoxy)vinylsilane, vinyl(2-methoxyethoxy)silane, vinyltriacetoxysilane, γ-aminopropyl triethoxysilane, γ-(2,3-epoxypropoxy)propytrimethoxysilane, γ-methacryloxypropyltrimethoxysilane, N-(2-aminoethyl) aminopropyltrimeth(eth)oxysilane and N-β-(aminoethyl)-γ-aminopropylmethyldimethoxysilane; and further preferably, the silane coupling agent is vinylsilane, which is one or a combination of a plurality of vinyltrimethoxysilane, vinyltriethoxysilane, vinyltris(2-methoxyethoxy)silane, tri(isopropoxy)vinylsilane, vinyl(2-methoxyethoxy)silane and vinyltriacetoxysilane.

The titanate coupling agent comprises, but is not limited to isopropyl tri(dioctylpyrophosphate)titanate, isopropyl tri(dioctylphosphate)titanate, isopropyl dioleic(dioctylphosphate)titanate, monoalkoxy unsaturated fatty acid titanate, a chelate of Bis(P,P-bis-ethylhexyl diphosphato)ethanediolato titanate and triethanolamine, and Bis(P,P-bis-ethylhexyl diphosphato)ethanediolato titanate.

The modified lignin is prepared by any one of the following methods:
(1) impregnation method: impregnating a lignin and a modifier into ethanol, methanol, acetone or water, and drying the mixture to obtain the modified lignin;
(2) blending method: blending a lignin and a modifier in a blender, thus obtaining the modified lignin; and
(3) airflow modification method: configuring a modifier into a solution of methanol, ethanol or acetone (if the modifier is a liquid, the modifier does not need to be configured into a solution, and may be directly sprayed), and then modifying the lignin by an integrated device for airflow pulverization and surface modification; wherein, the integrated device for airflow pulverization and surface modification is disclosed in CN101433876B “Integrated Device for Airflow Pulverization and Surface Modification and Technique thereof for Preparing Ultrafine Grain”.

Preferably, the preparation method for the modified lignin is: adding the compound containing the carbon-carbon double bond and the compound containing the sulfur element for modification first, and then adding the compound capable of blocking the hydroxyl for modification.

The impregnation method preferably comprises the following steps of:
(I) dispersing the compound containing the carbon-carbon double bond and the compound containing the sulfur element in ethanol to obtain a first solution; and dispersing the compound capable of blocking the hydroxyl into ethanol to obtain a second solution;
(II) dispersing the lignin into the first solution until the lignin reaches an infiltrated state (if the infiltrated state cannot be reached after dropwise adding the ethanol solution of the modifier, the ethanol can be directly dropwise added to make the lignin reach the infiltrated state) to obtain an ethanol solution of the lignin, and then standing and drying the ethanol solution of the lignin; and
(III) dispersing the lignin obtained in step (II) into the second solution until the lignin reaches an infiltrated state (if the infiltrated state cannot be reached after dropwise adding the ethanol solution of the modifier, the ethanol can be directly dropwise added to make the lignin reach the infiltrated state) to obtain an ethanol solution of the lignin, and then standing and drying the ethanol solution of the lignin to obtain the modified lignin.

In step (I), the dispersing is to dropwise add the ethanol into the compound containing the carbon-carbon double bonds and the compound containing the sulfur element.

In step (I), concentrations of the compound containing the carbon-carbon double bond, the compound containing the sulfur element and the compound capable of blocking the hydroxyl are not particularly required, as long as the compounds are uniformly dispersed, and the concentrations are all preferably 1 g/ml to 8 g/ml.

In step (II), the dispersing is to dropwise add the first solution into the lignin; and dosages of the compound containing the carbon-carbon double bond and the compound containing the sulfur element are both 1 wt % to 4 wt % of the lignin, and both are preferably 2 wt %.

In step (III), the dispersing is to dropwise add the second solution into the lignin obtained in step (II); and a dosage of the compound capable of blocking the hydroxyl is 0.5 wt % to 4 wt % of the lignin.

In the above process, there is no specific requirement for a dropwise adding rate.

In the blending method, the lignin, the compound containing the carbon-carbon double bond and the compound containing the sulfur element are preferably mixed in the blender until a temperature of the blender is 90° C. to 120° C., and then the compound capable of blocking the hydroxyl is added into the mixture for blending for 10 minutes to 20 minutes. The dosages of the compound containing the carbon-carbon double bond and the compound containing the sulfur element are both 1 wt % to 4 wt % of the lignin; and the dosage of the compound capable of blocking the hydroxyl is 0.5 wt % to 0.8 wt % of the lignin.

The airflow modification method preferably comprises the following steps of:
(i) dispersing the compound containing the carbon-carbon double bond and the compound containing the sulfur element in ethanol to obtain a third solution; and dispersing the compound capable of blocking the hydroxyl into ethanol to obtain a fourth solution;
(ii) spraying the third solution into a pulverizing cavity through an atomizing nozzle, so that the compound containing the carbon-carbon double bond and the compound containing the sulfur element are adsorbed on a lignin surface in the pulverizing cavity and pulverized for 2 minutes to 3 minutes; and
(iii) spraying the fourth solution into the pulverizing cavity through the atomizing nozzle, so that the compound capable of blocking the hydroxyl is adsorbed on a lignin surface in the pulverizing cavity and pulverized for 2 minutes to 4 minutes; and then separating by a cyclone separator to obtain the modified lignin.

In step (i), concentrations of the compound containing the carbon-carbon double bond, the compound containing the sulfur element and the compound capable of blocking the hydroxyl are not particularly required, as long as the compounds are uniformly dispersed, and the concentrations are all preferably 1 g/ml to 8 g/ml.

In step (ii), dosages of the compound containing the carbon-carbon double bond and the compound containing the sulfur element are both 1 wt % to 4 wt % of the lignin; and a temperature of pulverizing air is 90° C. to 120° C.

In step (iii), the dosage of the compound capable of blocking the hydroxyl is 0.5 wt % to 0.8 wt % of the lignin; and a temperature of pulverizing air is 90° C. to 120° C.

The rubber is any one of natural rubber, butyl rubber and styrene butadiene rubber.

The preparation method for the modified lignin reinforced rubber comprises the following steps of:
(1) adding the modified lignin, a rubber, carbon black, a vulcanizing agent and a vulcanizing aid into an internal mixer for mixing to obtain a rubber compound; and
(2) after the rubber compound obtained in the step (1) is placed in an open mill for repeated thinning, measuring a vulcanization property of the rubber compound by a rubber vulcanizer, and then hot-pressing and molding the rubber compound by a vulcanizing press.

In step (1), a mass ratio of the modified lignin to the rubber is (2-50): 100.

In step (1), a mass ratio of the rubber to the carbon black, the vulcanizing agent and the vulcanizing aid is 100: (1-20): (0.5-2.5): (0.5-10); and the mixing is performed at a temperature of 20° C. to 120° C., and the mixing lasts for 5 minutes to 30 minutes.

In step (2), the thinning is performed for 5 times to 30 times; a temperature of the vulcanizing press is 120° C. to 180° C., and a hot pressing time is an optimum curing time t₉₀ measured by the rubber vulcanizer.

The modified lignin reinforced rubber prepared by the method above is also within the scope of protection of the present invention.

Beneficial effects: compared with the prior art, the present invention has the following advantages:
(1) According to the present invention, the lignin is modified by the compound containing the carbon-carbon double bond, such that the lignin can have a long chain containing the carbon-carbon double bond, so that when the lignin reacts with the rubber, the contained double bond can generate a bonding effect with olefins in the rubber, to improve a binding force between the lignin and the rubber; moreover, the long chain of the modified lignin can also be entangled with the rubber, thus further improving an interaction between the two.
(2) According to the present invention, by modifying the lignin with the compound containing the sulfur element, the lignin contains a certain amount of the element sulfur, while the element sulfur can improve an interaction between the lignin and the rubber, which further improves the properties of the rubber prepared, and can reduce the use of a vulcanizing agent, and further increase a replacement amount of the lignin to the carbon black.
(3) According to the present invention, after being modified by the compound capable of blocking the hydroxyl, a polarity of the lignin can be significantly reduced, such that the polarity of the lignin is closer to that of the rubber, thus further improving the acting force between the rubber and the lignin, and integrally improving the properties of the rubber. Meanwhile, after blocking the hydroxyl, conglobation of the lignin can also be reduced, thus further improving the dispersibility of the lignin in the rubber.
(4) Compared with one-pot modification, the present invention adopts the compound containing the carbon-carbon double bond and the compound containing the sulfur element to modify the lignin first, and then uses the compound capable of blocking the hydroxyl to modify the lignin, which can effectively improve the modification effect of the lignin.

### BRIEF DESCRIPTION OF THE DRAWINGS

FIG. 1 shows water contact angles of lignin modified by different coupling agents.

FIG. 2 shows properties of rubbers in Embodiment 4.

### DETAILED DESCRIPTION

The present invention can be better understood from the following embodiments. However, those skilled in the art will easily understand that the contents described in the embodiments are only used to illustrate the present invention, and should not and will not limit the present invention described in detail in the claims.

The detection method in this embodiment was as follows:

Water contact angle test: pre-dried lignin samples were pressed into uniform slices by an infrared tablet press, and water contact angles of the sample slices were measured by a contact angle meter.

Particle size test: the dried lignin samples were added into water according to a solid-liquid ratio of 1:50, dispersed by ultrasonic for 30 minutes, and then a proper amount of the mixture was taken and dropwise added into a laser particle size analyzer for particle size analysis.

Tensile properties of rubber were tested on a UTM6104 electronic universal testing machine according to GB/T528-2009.

Rubber hardness testing method: a spline was placed on a Shore durometer A, and a handle was downwards pressed to make the durometer contact with the sample horizontally, and read the durometer in one second.

### Embodiment 1: Preparation of Modified Lignin (Impregnation Method)

According to Table 1, a compound containing a carbon-carbon double bond and a compound containing a sulfur element were weighed, stirred evenly, and added with ethanol, wherein concentrations of the compound containing the carbon-carbon double bond and the compound containing the sulfur element were both 2 g/mL to obtain a first solution. According to Table 1, a compound capable of blocking a hydroxyl was weighed, and added with ethanol, wherein a concentration of this compound was 2 g/ml, to obtain a second solution. If the compound the containing the carbon-carbon double bond, the compound containing the sulfur element and the compound capable of blocking the hydroxyl listed in Table 1 do not need to be dissolved in ethanol, the compounds could be used directly, and dosages of these compounds were controlled according to the description in the following two paragraphs.

The first solution was dropwise added in 10 g of enzymatic hydrolysis lignin (the dosage of the compound containing the carbon-carbon double bond and the compound containing the sulfur element were both 2 wt % of that of the enzymatic hydrolysis lignin), and then dropwise added with ethanol (about 8 mL) until the lignin reached an infiltrated state, thoroughly mixed, and stood for 30 minutes. The modified lignin was put into a vacuum drying oven, dried at 60° C. in vacuum to completely volatilize the ethanol, and then pulverized for 2 minutes with a pulverizer.

The second solution was dropwise added in the pulverized material (the dosage of the compound capable of blocking the hydroxyl was 4 wt % of that of the enzymatic hydrolysis lignin), and then dropwise added with ethanol until the lignin reached the infiltrated state, thoroughly mixed, and stood for 30 minutes. The modified lignin was put into a vacuum drying oven, dried at 60° C. in vacuum to completely volatilize the ethanol, and then pulverized for 1 minute with a pulverizer.

TABLE 1

| | Compound containing | | |
|---|---|---|---|
| Serial | a carbon-carbon | Compound containing a | Compound capable of |
| No. | double bond | sulfur element | blocking a hydroxyl |
| 1 | Zinc acrylate | Tetramethyl thiuram | Vinyltriacetoxysilane |
| | | monosulfide | |
| | Zinc acrylate | Tetramethyl thiuram | Diisobutoxy(ethylacetoacetate)titanate |
| 2 | | monosulfide | |
| | Zinc acrylate | Tetramethyl thiuram | Isopropyl |
| 3 | | monosulfide | dioleic(dioctylphosphate)titanate |
| 4 | Zinc acrylate | Tetramethyl thiuram | Vinyltriacetoxysilane |
| | | monosulfide | |
| 5 | Zinc acrylate | 2-mercaptobenzothiazole | Vinyltriacetoxysilane |
| 6 | Zinc acrylate | Bis[3- | Vinyltriacetoxysilane |
| | | (triethoxysilyl)propyl]tetrasulfide | |
| 7 | Zinc acrylate | 3- | Vinyltriacetoxysilane |
| | | mercaptopropyltriethoxysilane | |
| 8 | Zinc acrylate | (3- | Vinyltriacetoxysilane |
| | | mercaptopropyl)trimethoxysilane | |
| 9 | Vinyltrimethoxysilane | 2-mercaptobenzothiazole | Vinyltriacetoxysilane |
| 10 | Vinyltris(2- | 2-mercaptobenzothiazole | Vinyltriacetoxysilane |
| | methoxyethoxy)silane | | |
| 11 | Isopropyl trioleyl | 2-mercaptobenzothiazole | Vinyltriacetoxysilane |
| | titanate | | |
| 12 | Vinyltrimethoxysilane | 2-mercaptobenzothiazole | / |
| 13 | Vinyltrimethoxysilane | / | Vinyltriacetoxysilane |
| 14 | / | 2-mercaptobenzothiazole | Vinyltriacetoxysilane |
| 15 | Vinyltrimethoxysilane | / | / |
| 16 | / | 2-mercaptobenzothiazole | / |
| 17 | / | / | Vinyltriacetoxysilane |

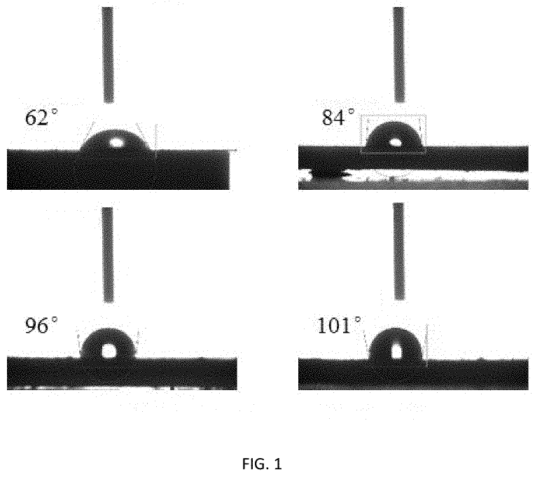

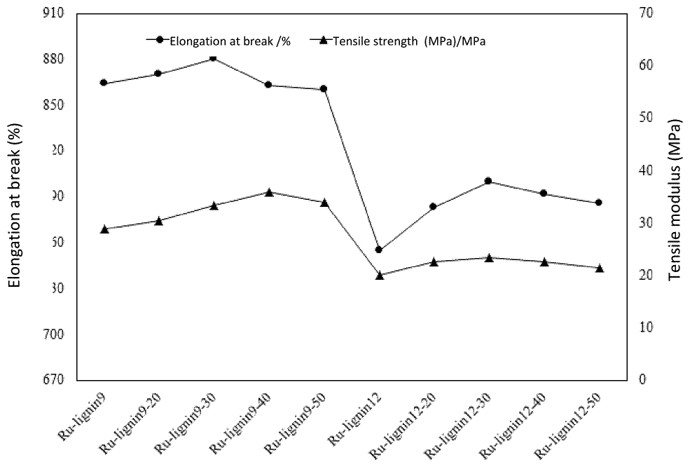

The results were analyzed according to Table 2 and FIG. 1:
(1) The contact angle of the enzymatic hydrolysis lignin was tested. As can be seen from Table 2, the contact angles of the modified lignin are all increased in comparison to the contact angle of the unmodified lignin, which was 62°.
(2) Compared with other modifications, the hydroxyl was not blocked in Examples 1-12, and the contact angle of the modified lignin was 80°, which was lower than that of other embodiment in Embodiment 1, indicating that it was very necessary to use the compound that can block the hydroxyl for modification. Examples 1-1 to 1-3 used different compounds to block the hydroxyl of the enzymatic hydrolysis lignin, and contact angles of the three embodiments were similar.
(3) Embodiments 1-4 to 1-8 studied influences of different sulfides on the contact angle. The results showed that different sulfides had no significant influence on the contact angles except for Examples 1-7 and 1-8, because a silane coupling agent was used in Embodiments 1-7 and 1-8, which contained sulfhydryl and silane at the same time, and had a certain function of blocking the hydroxyl.
(4) In Embodiments 1-9 to 1-11, different compounds containing carbon-carbon double bonds were used for modification, and vinyltriacetoxysilane was used to block hydroxyl. Compared with an acrylic acid, these three examples used long chains containing double bonds for modification, and the contact angle of the modified enzymatic hydrolysis lignin was obviously improved, especially in Embodiment 1-9, the contact angle thereof reached 101, which showed that the polarity of the lignin was greatly improved.

TABLE 2

| Serial No. | Contact angle |
|---|---|
| 0 (unmodified enzymatic hydrolysis lignin) | 62° |
| 1 | 93° |
| 2 | 89° |
| 3 | 93° |
| 4 | 94° |
| 5 | 95° |
| 6 | 94° |
| 7 | 104° |
| 8 | 105° |
| 9 | 101° |
| 10 | 96° |
| 11 | 98° |
| 12 | 80° |
| 13 | 85° |
| 14 | 81° |
| 15 | 77° |
| 16 | 63° |
| 18 | 78° |

### Embodiment 2: Preparation of Modified Lignin (Airflow Modification Method)

According to the serial numbers 4, 9, 10 and 12 in Table 1, a first solution and a second solution were prepared in the same way as in Embodiment 1.

Enzymatic hydrolysis lignin was sprayed into a pulverizing cavity by high-pressure air at about 100° C., and at the same time, the first solution (flow rate was 40 mL/min) was sprayed into the pulverizing cavity through an atomizing nozzle, and a rotating speed of an air classification wheel was 2,000 rpm, running for 2 minutes; then, the second solution (flow rate was 40 mL/min) was sprayed into the pulverizing cavity through the atomizing nozzle, and a rotating speed of an air classification wheel was 2,000 rpm, running for 3 minutes; and then the lignin was separated by a cyclone separator to obtain four kinds of modified lignin, namely ligni4, lignin9, lignin10 and lignin12. Particle sizes of the modified lignin were tested by S3500 laser particle size analyzer by American Microtrac, and D50 of the four were 1.6 μm, 1.4 μm, 1.7 μm and 2.3 μm respectively. However, in Embodiment 1, the particle size of the modified lignin prepared by the same method was higher than these four particle sizes. It follows that the particle size of the lignin can be further reduced by air flow pulverization, which is more conducive to the application of the lignin in the rubber.

### Embodiment 3: Preparation of Lignin Reinforced Rubber

(1) 10 g of enzymatic hydrolysis lignin (particle size was pulverized to 2.1 μm by air flow), the lignin4, the lignin9, the lignin10 and the lignin12 prepared in Embodiment 2, and the lignin13 and the lignin14 (the serial No. 13 and the series number 14 in Table 1) prepared according to Embodiment 2, 40 g of natural rubber, 10 g of high wear-resistant carbon black N330, 1 g of sulfur, 0.6 g of N-cyclohexylbenzothiazole-2-sulphenamide, 2 g of zinc oxide and 0.8 g of stearic acid were respectively taken and added into an internal mixer in turn, and mixed at 100° C. for 20 minutes.
(2) The rubber compound obtained in step (1) was put in an open mill and thinned for 7 times, and a vulcanization property of the rubber compound was measured by a rubber vulcanizer to obtain that an optimum curing time t90 at 180° C. was 3 minutes, and then the rubber compound was hot-pressed and molded by a vulcanizing press at 180° C. for 3 minutes, and the obtained rubbers were respectively named as Ru-lignin, Ru-lignin4, Ru-lignin9 and Ru-lignin10, Ru-lignin12, Ru-lignin13 and Ru-lignin14. The detection results of the rubbers were as shown in Table 3.

TABLE 3
Properties of vulcanized rubber

| | | | 300% | 100% | | |
|---|---|---|---|---|---|---|
| | | Elonga- | stress at | stress at | | |
| | Tensile | tion | definite | definite | Tensile | |
| | strength | at break | elongation | elongation | set | Hard- |
| | (MPa) | (%) | (MPa) | (MPa) | (%) | ness |
| Ru-lignin | 7.9 | 340 | 2.9 | 1.3 | 2.2 | 63 |
| Ru-lignin4 | 27.93 | 861 | 6.2 | 3.4 | 11.1 | 81 |
| Ru-lignin9 | 28.9 | 864 | 7.2 | 3.9 | 11.5 | 82 |
| Ru-lignin10 | 26.3 | 862 | 6.1 | 3.4 | 10.5 | 78 |
| Ru-lignin12 | 20.1 | 755 | 4.7 | 1.9 | 7.8 | 70 |
| Ru-lignin13 | 15.9 | 693 | 3.8 | 1.5 | 6.7 | 65 |
| Ru-lignin14 | 18.7 | 731 | 4.1 | 1.8 | 7.4 | 68 |

It can be seen from Table 3 that under the same particle size, compared with the unmodified lignin, the properties of the rubber prepared after being modified by the lignin are greatly improved. Compared with the lignin lignin12, the lignin13 and the lignin14 with the hydroxyl not blocked, the ligni4, the lignin13 and the lignin14 modified by three compounds at the same time can significantly improve the properties of the rubber after increasing the contact angle. Meanwhile, the lignin4 is modified by zinc acrylate with double bonds. Although a chain length of the zinc acrylate is not as long as that of vinyltrimethoxysilane, the zinc acrylate is beneficial to vulcanization with the rubber, so the zinc acrylate can also achieve a similar effect as the lignin9.

### Embodiment 4

In the same way as the preparation method for the Ru-lignin9 in Embodiment 3, the natural rubber was changed into butyl rubber and neoprene rubber. Properties of the rubber prepared by the butyl rubber were tested, and a tensile strength, an elongation at break, a 300% stress at definite elongation, a 100% stress at definite elongation, a tensile set and a hardness of the rubber were 27.8 MPa, 870%, 7.5 MPa, 3.6 MPa, 11.7% and 79 respectively. Properties of the rubber prepared by the neoprene rubber were tested, and a tensile strength, an elongation at break, a 300% stress at definite elongation, a 100% stress at definite elongation, a tensile set and a hardness of the rubber were 18.3 MPa, 578%, 5.8 MPa, 4.4 MPa, 3.9% and 65 respectively. It follows that, compared with the natural rubber, the modified lignin prepared by the present invention is not suitable for polar neoprene rubber.

### Comparative Example 1: Preparation Method in Other Sequences

The modified lignin was prepared according to the formulation of serial No. 9 in Table 1. The same preparation method as in Embodiment 2 was adopted, except that the sequence of the first solution and the second solution was changed to obtain the modified lignin lignin91.

The modified lignin was prepared according to the formulation of serial No. 9 in Table 1. The same preparation method as in Embodiment 2 was adopted, except that the first solution and the second solution were mixed. That is, enzymatic hydrolysis lignin was sprayed into a pulverizing cavity by high-pressure air at about 100° C., and the mixed solution of the first solution and the second solution (flow rate was 40 mL/min) was sprayed into the pulverizing cavity by an atomizing nozzle, and a rotating speed of an air classification wheel was 2,000 rpm, running for 5 minutes, and then separated by a cyclone separator to obtain the modified lignin lignin92.

In the same way as the preparation method for the Ru-lignin9 in Embodiment 3, the lignin9 was respectively changed into the lignin91 and the lignin92 respectively to obtain rubbers Ru-lignin9l and Ru-lignin92. Properties of the rubber were detected. It can be seen from Table 4 that compared with the preparation sequence of the present invention, after the first solution and the second solution are changed in sequence, namely, the hydroxyl is blocked first, and then the compound containing the sulfur element and the compound containing the double bond are used for modification, and the properties of the rubber are worse than that of using the three together.

TABLE 4

| | | | 300% | 100% | | |
|---|---|---|---|---|---|---|
| | | Elonga- | stress at | stress at | | |
| | Tensile | tion | definite | definite | Tensile | |
| | strength | at break | elongation | elongation | set | Hard- |
| | (MPa) | (%) | (MPa) | (MPa) | (%) | ness |
| Ru-lignin9 | 28.9 | 864 | 7.2 | 3.9 | 11.5 | 80 |
| Ru-lignin91 | 20.0 | 786 | 4.9 | 2.6 | 8.1 | 70 |
| Ru-lignin92 | 21.1 | 805 | 5.2 | 2.5 | 7.9 | 72 |

### Comparative Example 4

The modified lignin was prepared respectively according to the substances in the formulation of serial No. 9 in Table 1. The same preparation method as in Embodiment 2 was adopted, that is, three compounds were prepared into solutions to obtain solutions of three compounds; enzymatic hydrolysis lignin was sprayed into a pulverizing cavity by high-pressure air at about 100° C., and the solutions of the three compounds (flow rate was 40 mL/min) were sprayed into the pulverizing cavity by an atomizing nozzle respectively, and a rotating speed of an air classification wheel was 2,000 rpm, running for 5 minutes, and then separated by a cyclone separator to obtain the modified lignin lignin93 (modified by vinyltrimethoxysilane), the lignin94 (modified by 2-mercaptobenzothiazole) and the lignin95 (modified by vinyltriacetoxysilane).

In the same way as the preparation method for the Ru-lignin9 in Embodiment 3, the lignin9 was respectively changed into the lignin93, the lignin94 and the lignin95 respectively to obtain rubbers Ru-lignin93, Ru-lignin94 and Ru-lignin95. Properties of the rubber were detected, and the results were seen in Table 5. It can be seen from Table 5 that although the properties are improved to some extent, the improvement effect is small, and the present invention can achieve a good effect only when the three are used at the same time.

TABLE 5

| | Tensile strength | Elongation at break | |
|---|---|---|---|
| | (MPa) | (%) | Hardness |
| Ru-lignin9 | 28.9 | 864 | 80 |
| Ru-lignin93 | 12.6 | 408 | 68 |
| Ru-lignin94 | 13.8 | 415 | 68 |
| Ru-lignin93 | 12.9 | 410 | 70 |

### Embodiment 5

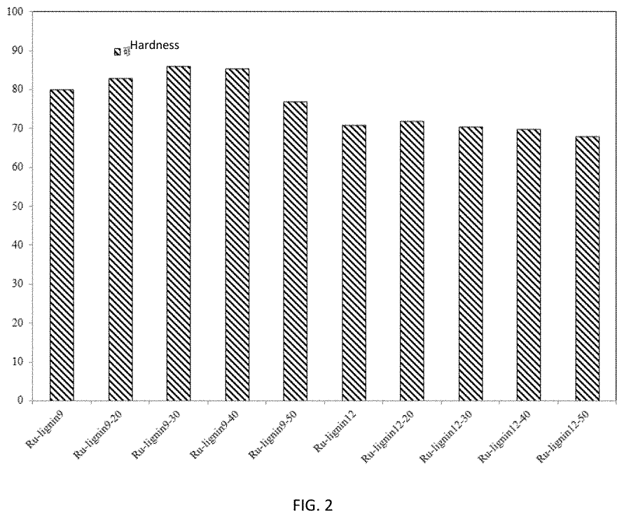

In the same way as the preparation method of Ru-lignin9 in Embodiment 3, the dosages of the lignin9 were changed to 20 parts, 30 parts, 40 parts and 50 parts respectively, and the prepared rubbers were respectively named as Ru-lignin9-20, Ru-lignin9-30, Ru-lignin9-40 and Ru-lignin9-50. Moreover, in the same way as the preparation method of Ru-lignin12 in Embodiment 3, the dosages of the lignin12 were changed to 20 parts, 30 parts, 40 parts and 50 parts respectively, and the prepared rubbers were respectively named as Ru-lignin12-20, Ru-lignin12-30, Ru-lignin12-40 and Ru-lignin12-50. The detection results were shown in FIG. 2. It can be seen from the figure that the dosage of the lignin9 can reach 50 parts. Although the properties of the Lignin 9 decrease at the dosage of 50 parts, the properties are still higher than the original dosage of 10 parts, while the properties of the Ru-lignin12 decrease at the dosage of 30 parts with the increase of the dosage of the lignin12. Therefore, after the modifier with long chain and double bonds is selected by the present invention to modify the lignin, the properties of the rubber can be significantly improved, and the replacement amount of the lignin to the carbon black can be further improved.

The present invention provides the ideas and methods of the modified lignin reinforced rubber and the preparation method therefor. There are many methods and ways to realize the technical solutions. The above is only the preferred embodiments of the present invention. It should be pointed out that those of ordinary skills in the art can make some improvements and embellishments without departing from the principle of the present invention, and these improvements and embellishments should also be regarded as falling with the scope of protection of the present invention. All the unspecified components in the embodiments can be realized by the prior art.

What is claimed is:

1. A preparation method for a modified lignin reinforced rubber, wherein the modified lignin is obtained by subjecting a lignin to composite modification by a compound containing a carbon-carbon double bond, a compound containing a sulfur element and a compound capable of blocking a hydroxyl.

2. The preparation method for the modified lignin reinforced rubber according to claim 1, wherein the lignin is one or a combination of a plurality of alkali lignin, soda lignin, organic solvent lignin and enzymatic hydrolysis lignin.

3. The preparation method for the modified lignin reinforced rubber according to claim 1, wherein the compound containing the carbon-carbon double bond is a compound containing any one of vinyl, acrylic, butadiene, oleic, linoleic, linolenic, arachidonic and dienyl phthalate groups.

4. The preparation method for the modified lignin reinforced rubber according to claim 2 or 3, wherein the compound containing the carbon-carbon double bond is a long-chain compound containing no less than five carbon atoms.

5. The preparation method for the modified lignin reinforced rubber according to claim 1, wherein the compound containing the sulfur element is any one or a combination of a plurality of sulfhydryl silane coupling agent shown in formula I, bis[3-(triethoxysilyl)propyl]tetrasulfide, mercaptan, potassium persulfate, mercaptobenzothiazole, brimstone and tetramethyl thiuram monosulfide; 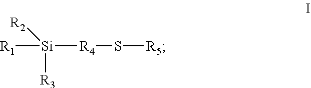
wherein, R₁, R₂ and R₃ are independently selected from —O—R₆; wherein, R₆ is selected from alkyl, alkenyl, aryl or aralkyl;
R₄ is selected from —(CH₂)ₙ—; wherein, n is any integer selected from 1 to 10; and
R₅ is selected from H, CN or (C═O)—R⁶; wherein, R⁶ is selected from branched or unbranched, saturated or unsaturated aliphatic, aromatic or mixed aliphatic/aromatic monovalent C1-C30 hydrocarbyl groups.

6. The preparation method for the modified lignin reinforced rubber according to claim 1, wherein the compound capable of blocking the hydroxyl is one or a combination of a plurality of silane coupling agent, titanate coupling agent and aluminate coupling agent.

7. The preparation method for the modified lignin reinforced rubber according to claim 1, wherein the preparation method for the modified lignin is: adding the compound containing the carbon-carbon double bond and the compound containing the sulfur element for modification first, and then adding the compound capable of blocking the hydroxyl for modification.

8. The preparation method for the modified lignin reinforced rubber according to claim 1, wherein the rubber is any one of natural rubber, butyl rubber and styrene butadiene rubber.

9. The preparation method for the modified lignin reinforced rubber according to claim 1, comprising the following steps of:
(1) adding the modified lignin, a rubber, carbon black, a vulcanizing agent and a vulcanizing aid into an internal mixer for mixing to obtain a rubber compound; and
(2) after the rubber compound obtained in step (1) is placed in an open mill for repeated thinning, measuring a vulcanization properties of the rubber compound by a rubber vulcameter, and then hot-pressing and molding the rubber compound by a vulcanizing press.

10. The preparation method for the modified lignin reinforced rubber according to claim 7, wherein in step (1), a mass ratio of the modified lignin to the rubber, the carbon black, the vulcanizing agent and the vulcanizing aid is (2-50):100:(1-20):(0.5-2.5):(0.5-10).
